(19) United States
(12) Patent Application Publication
(10) Pub. No.: US 2018/0281537 A1
(43) Pub. Date: Oct. 4, 2018

(54) Multi-Dimensional Vehicle

(71) Applicant: Joshua Leppo, Lebanon, CT (US)

(72) Inventor: Joshua Leppo, Lebanon, CT (US)

(21) Appl. No.: 15/861,087

(22) Filed: Jan. 3, 2018

Related U.S. Application Data
(60) Provisional application No. 62/441,656, filed on Jan. 3, 2017.

(51) Int. Cl. B60F 5/02; B64C 39/02; B60F 3/00

(52) U.S. Cl. CPC B60F 5/02; B64C 39/024; B64C 27/473; B64C 2201/146; B64C 2203/00; B60F 3/0061

(57) ABSTRACT

A multi-dimensional vehicle configured for aerial and ground mobility is provided and includes a vehicle body, a plurality of vehicle wheels movably associated with the vehicle body and configurable between a ground mobility configuration and an aerial mobility configuration and a control device, wherein the control device is configured for wireless communication and is associated with the plurality of vehicle wheels to controllably operate the plurality of vehicle wheels and to controllably configure the plurality of vehicle wheels between the ground mobility configuration and the aerial mobility configuration, wherein each of the plurality of vehicle wheels include a wheel rim having an inner rim circumference and a plurality of fan blades distributed along the inner rim circumference, wherein the plurality of fan blades are configured to create a flow channel between each of the plurality of fan blades and an adjacent fan blade.

### RELATED APPLICATIONS

This application is related to and claims benefit of the filing date of U.S. Provisional Patent Application Ser. No. 62/441,656 (Atty. Docket No. LEP-0001-P), filed Jan. 3, 2017, the contents of which are incorporated by reference herein in its entirety.

### FIELD OF THE INVENTION

This invention relates generally to vehicles and more particularly to remote control vehicles having aerial, ground and aquatic mobility capability with a combination rotor/wheel assembly.

### BACKGROUND OF THE INVENTION

Vehicles that have both aerial and ground mobility capability are well known and are used for many different applications, including military and police operations as well as personal use. Typically, these vehicles include both rotors (for aerial mobility) and wheels (for ground mobility) arranged in a variety of configurations.

In one such configuration, the vehicle includes two completely separate systems: a rotor system and a wheel system where power may be switched between the two systems. This type of configuration typically includes one set of motors to drive the wheels and another set of motors to drive the rotors. Unfortunately, having multiple motors is undesirable for at least three reasons: 1) multiple motors take up valuable space which not only increases the size and cost of the vehicle but also limits the power of the available motors, 2) multiple motors increase the weight of the vehicle thereby requiring motors that have enough power to lift and/or propel the entire system, and 3) having multiple motors increases the complexity of the control which has to be configured to control all of the motors simultaneously or individually.

In another such configuration, the vehicle includes an integrated rotor/wheel system, where the rotor forms part of the wheel support. For example, rotor functions as the “rim” of the wheel and when not being used for lift the rotor remains stationary. When the rotor is being used for lift the rotor rotates within the wheel cavity. As with the first configuration, the rotor system and the wheel system are basically separate and typically require separate motors. Accordingly, most if not all of the same issues present with the first configuration are present with this configuration with the addition that additional motors are required to configure the wheel/rotor combination between a horizontal configuration and a vertical configuration.

### SUMMARY OF THE INVENTION

A multi-dimensional vehicle configured for aerial and ground mobility is provided and includes a vehicle body, a plurality of vehicle wheels, wherein the plurality of vehicle wheels are movably associated with the vehicle body and configurable between a ground mobility configuration and an aerial mobility configuration and a control device, wherein the control device is configured for wireless communication and is associated with the vehicle body and the plurality of vehicle wheels to controllably operate the plurality of vehicle wheels and to controllably configure the plurality of vehicle wheels between the ground mobility configuration and the aerial mobility configuration, wherein each of the plurality of vehicle wheels include a wheel rim having an inner rim circumference and a plurality of fan blades distributed along the inner rim circumference, wherein the plurality of fan blades are configured to create a flow channel between each of the plurality of fan blades and an adjacent fan blade.

A multi-dimensional vehicle configured for aerial and ground mobility is provided and includes a vehicle body, a plurality of vehicle wheels rotatably associated with the vehicle body, wherein the plurality of vehicle wheels are movably associated with the vehicle body and configurable between a plurality of mobility configurations and a control device, wherein the control device is associated with the plurality of vehicle wheels to controllably operate the plurality of vehicle wheels and to controllably configure the plurality of vehicle wheels between the plurality of mobility configurations, wherein each of the plurality of vehicle wheels include a wheel rim having an inner rim circumference and a plurality of fan blades distributed along the inner rim circumference.

A vehicle wheel for use with a multi-dimensional vehicle configured for aerial and ground mobility is provided and includes a wheel rim, wherein the wheel rim includes, a rim support structure having a rim outer structure and a rim inner structure, a rim center structure; and a plurality of rim blades, wherein the plurality of rim blades connect the rim center structure with the rim inner structure, and wherein the plurality of rim blades are configured to generate an air flow between the plurality of rim blades when the vehicle wheel is rotated.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1A is a top down view of a Remote Control Vehicle (RCV) in the first (ground mobility) configuration, in accordance with one embodiment of the invention.

FIG. 1B is a front down view of a Remote Control Vehicle (RCV) in the second (air mobility) configuration, in accordance with one embodiment of the invention.

FIG. 1C is a top down view of a Remote Control Vehicle (RCV) in the third (aquatic mobility) configuration, in accordance with one embodiment of the invention.

FIG. 2 is a top down view of the Remote Control Vehicle (RCV) of FIG. 1, with the vehicle body cover removed.

FIG. 3 is a top down view of one of the wheel arms of the Remote Control Vehicle (RCV) of FIG. 1.

FIG. 4 is a top down rear view of the Remote Control Vehicle (RCV) of FIG. 1, with the vehicle body cover removed.

FIG. 5 is a top down view of one of the wheel arms of the Remote Control Vehicle (RCV) of FIG. 1 with a wheel connected.

FIG. 6 is a rear view of the Remote Control Vehicle (RCV) of FIG. 1 showing one wheel in the first configuration with a support wheel in the stowed configuration and one wheel in the second configuration with a support wheel in the unstowed configuration.

FIG. 7 is a side view of the Remote Control Vehicle (RCV) of FIG. 1 showing a support wheel in the unstowed configuration.

FIG. 8 is a top down front view of the Remote Control Vehicle (RCV) of FIG. 1, with the vehicle body cover connected.

FIG. 9 is a top down view of a wheel for use with the Remote Control Vehicle (RCV) of FIG. 1.

FIG. 10 is a top down front view of the first and second vehicle wheels for the Remote Control Vehicle (RCV) of FIG. 1, showing opposite orientation of the fan blades.

FIG. 11A is a side view of one embodiment of the wheel rim for the vehicle wheels for the Remote Control Vehicle (RCV) of FIG. 1.

FIG. 11B is a side view of another embodiment of the wheel rim for the vehicle wheels for the Remote Control Vehicle (RCV) of FIG. 1.

FIG. 12 is a top down rear view of the vehicle wheels of the Remote Control Vehicle (RCV) of FIG. 1 configured into the aerial configuration.

FIG. 13 is a rear view of the vehicle wheels of the Remote Control Vehicle (RCV) of FIG. 1 configured into the aerial configuration.

FIG. 14 is a top down view of the vehicle body cover removed from the vehicle main body.

FIG. 15 is a side view of a wheel assembly for the Remote Control Vehicle (RCV) of FIG. 1, showing the vehicle wheel being configured between the second configuration and the third configuration.

FIG. 16 is a front view of the wheel assembly of FIG. 15, showing the vehicle wheel configured into the second configuration.

FIG. 17 is a right side view of a rear motor mount/transition wheel leg for the Remote Control Vehicle (RCV) of FIG. 1, in accordance with another embodiment of the invention.

FIG. 18 is a left side view of the rear motor mount/transition wheel leg of FIG. 17 for the Remote Control Vehicle (RCV) of FIG. 1.

FIG. 19 is a side view of a front transition wheel leg for the Remote Control Vehicle (RCV) of FIG. 1, in accordance with another embodiment of the invention.

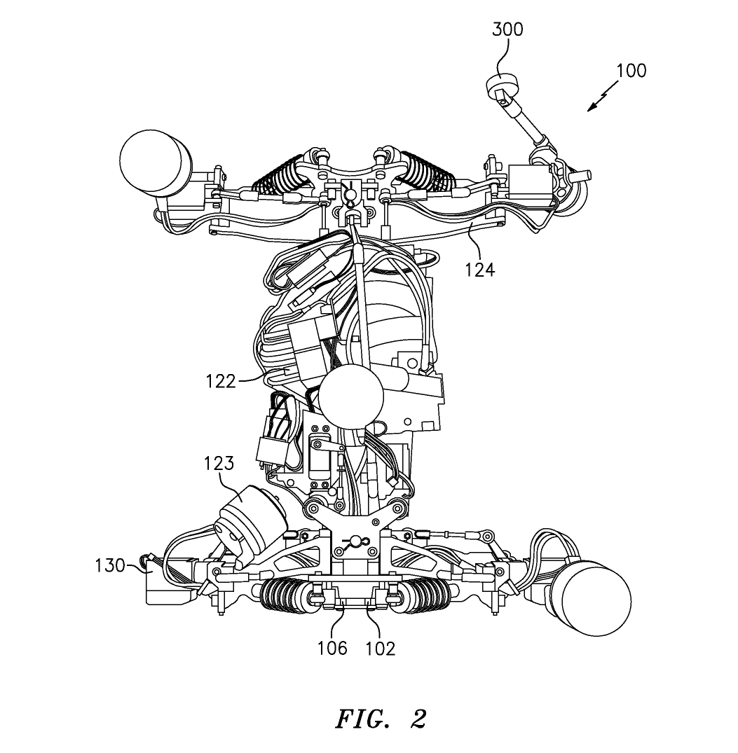

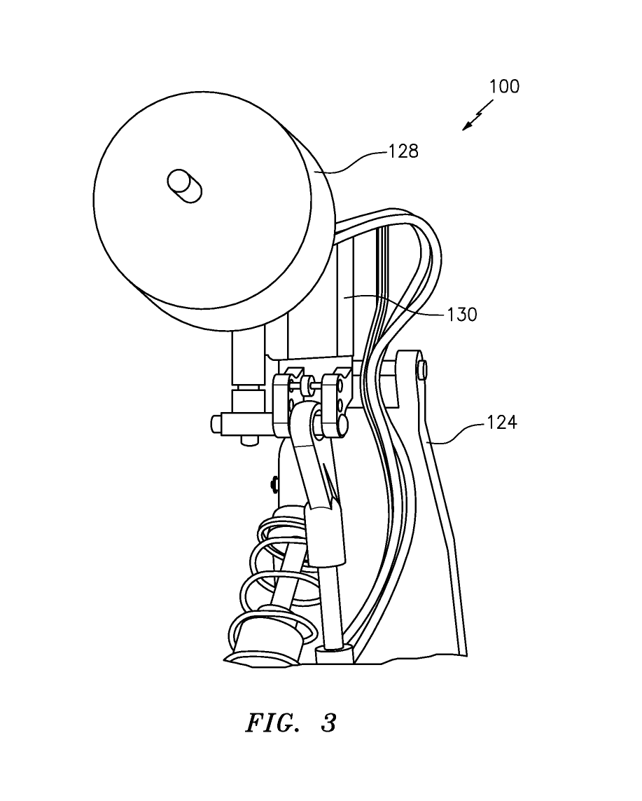

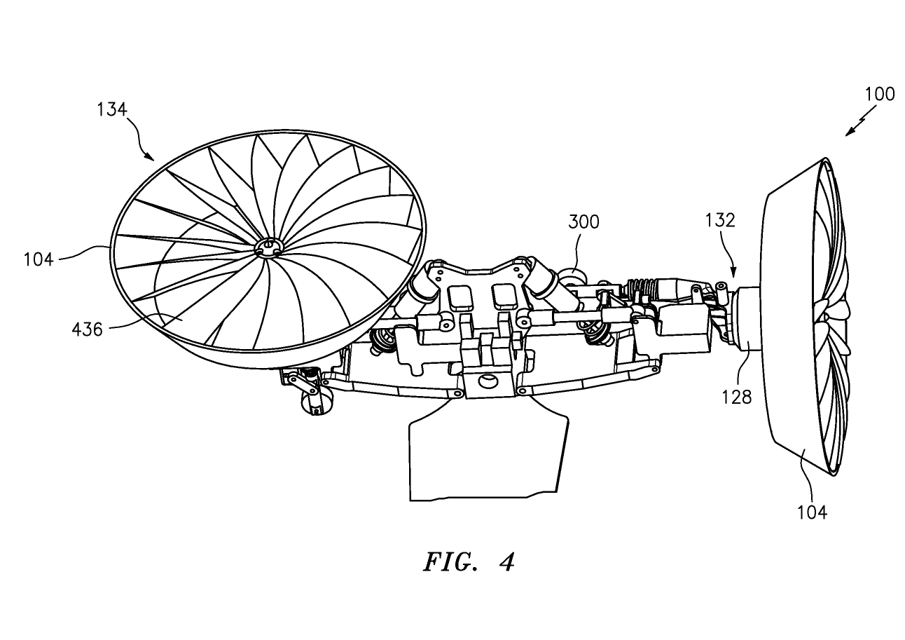

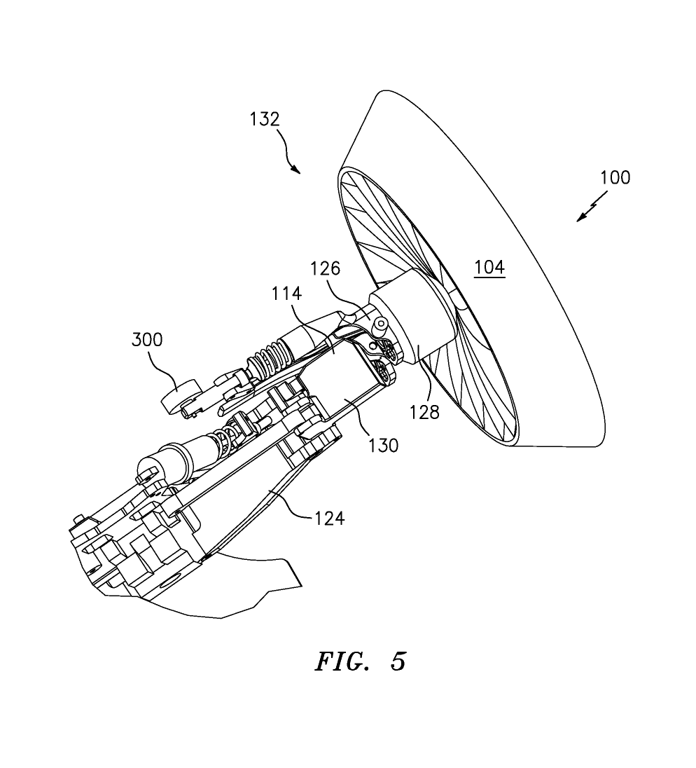

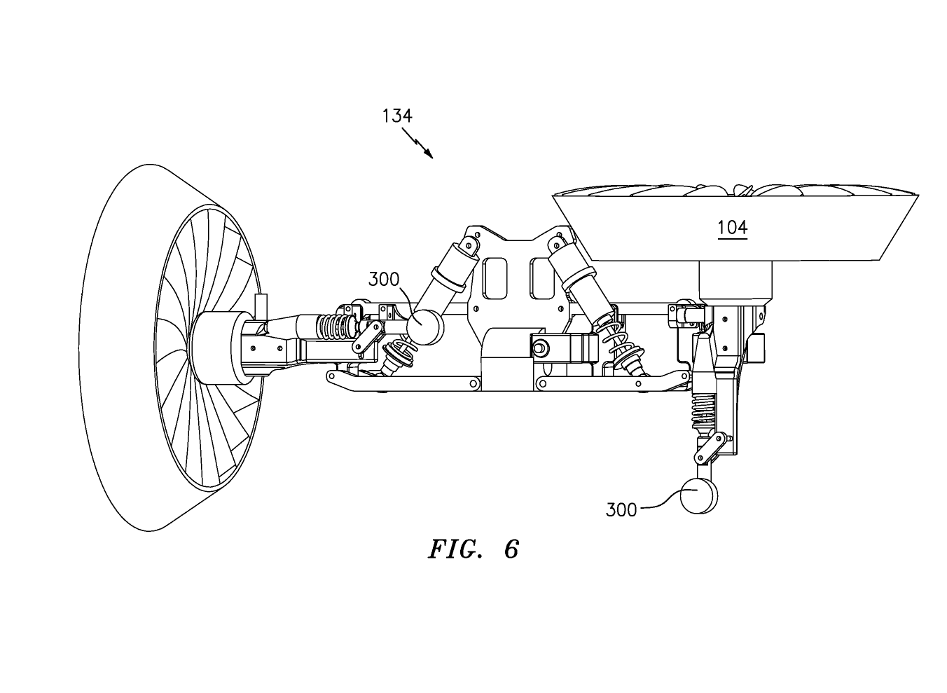

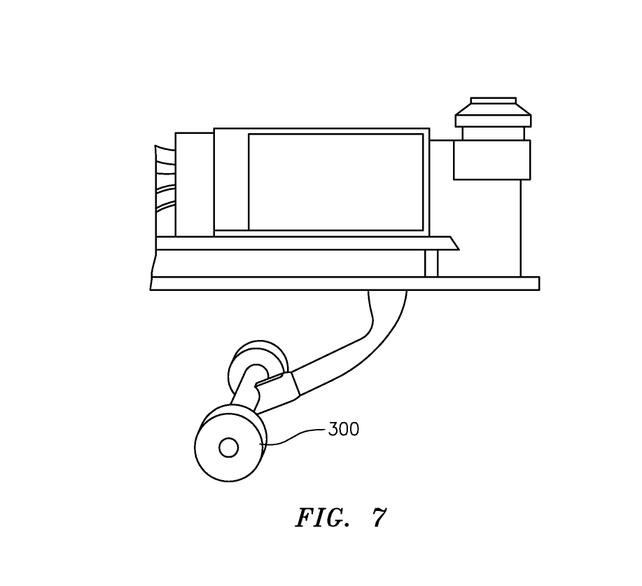

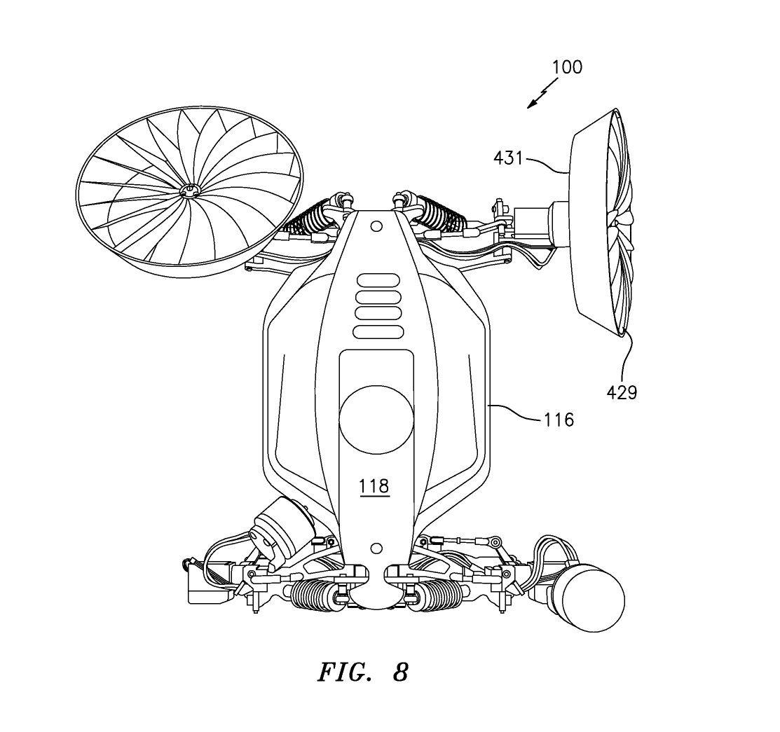

### DETAILED DESCRIPTION OF THE INVENTION

As disclosed herein with regards to an exemplary embodiment and referring to the FIGs, a Remote Control Vehicle (RCV) 100 having ground, aerial and aquatic mobility capability is provided and includes a vehicle main body 102 and a plurality of vehicle wheels 104, wherein the vehicle main body 102 includes a vehicle front 106, a vehicle rear 108, a vehicle top 110 and vehicle sides 112. Each of the plurality of vehicle wheels 104 are movably connected to the vehicle main body 102 via a wheel arm 114. The vehicle main body 102 further includes a vehicle body cover 116 which defines a body cavity 118 for containing a processing device 120 and/or control circuitry 122. As discussed hereinafter, the vehicle body cover 116 may be removably associated with the vehicle main body 102 and may be removable and/or configurable to be more aerodynamic, as desired. It should be appreciated that the vehicle body cover 116 may be associated with the vehicle main body 102 via any method and/or device suitable to the desired end purpose, such as friction fit, snap fit, clip, screws, etc.

Each of the wheel arms 114 includes a first arm portion 124 and a second arm portion 126, wherein the first arm portion 124 is connected (movably or non-movably as desired) to the vehicle main body 102 and wherein the second arm portion 126 is connected (movably or non-movably as desired) to the vehicle wheel 104. It should be appreciated that the RCV 100 further includes four (4) wheel motors 128, wherein one of each of the four (4) wheel motors 128 is associated with one of each of the vehicle wheels 104, such that the respective wheel motor 128 controllably drives (i.e. powers) the vehicle wheel 104 to cause the vehicle wheel 104 to rotate about an axis M. Additionally, the RCV 100 further includes four (4) arm motors 130, wherein one of each of the four (4) arm motors 130 is associated with one of each of the wheel arms 114 to controllably configure the second arm portions 126 between a first configuration 132 and a second configuration 134. It should be appreciated that an additional motor 127 may be included to controllably configure the second arm portions 126 between a first configuration 132/second configuration 134 and a third configuration 136 as illustrated in FIG. 15 and FIG. 16.

This advantageously allows the arm motor 130 to controllably configure the second arm portion 126 between the X, Y and/or Z plane to go between the first configuration 132, the second configuration 134 and the third configuration 136. It should be appreciated that when the second arm portion 126 is configured into the first configuration 132, the RCV 100 is configured for ground mobility and the plurality of vehicle wheels 104 are aligned to rotate in a direction that is substantially parallel to the vehicle sides 112 (plus or minus approximately 45°) and toward at least one of the vehicle front 106 and/or vehicle rear 108 of the RCV 100. When the second arm portion 126 is configured into the second configuration 134, the RCV 100 is configured for air mobility and the plurality of vehicle wheel(s) 104 are aligned to rotate in a direction that is substantially horizontal relative to the first arm portion 114, plus or minus approximately 20°. When the second arm portion 126 is configured into the third configuration 136, the RCV 100 is configured for aquatic mobility and the plurality of wheels 104 are aligned to rotate in a direction that is substantially directed toward the vehicle sides 112 and substantially perpendicular to the vehicle front 106 and vehicle rear 108 of the RCV 100. It should be appreciated that in one embodiment, an additional arm portion may be included and the arm motor 127 may controllably configure the additional arm portion (and/or the second arm portion 126) between the first configuration 132 and/or the second configuration 134 and the third configuration 136.

It should be appreciated that the processing device 120 and/or control circuitry 122 are configured to communicate with a wireless handheld remote control device to receive operational command signals from the wireless handheld remote control device. Additionally, the processing device 120 and/or control circuitry 122 are in signal communication (via hardwired and/or wireless) with and operably control the wheel motor(s) 128 and the arm motor(s) 130 based, at least in part, on the signals received by the wireless handheld remote control device. It is contemplated that in some embodiments, the processing device 120 and/or control circuitry 122 may be programmable to follow a predetermined route.

It should be appreciated that in one embodiment, the RCV 100 further includes support wheels 300 which are configurable between a stowed configuration and an unstowed configuration. When the vehicle wheels 104 are configured into the first configuration 132, the support wheels 300 are stowed to prevent the support wheels 300 from interfering with the ground mobility and/or aquatic mobility. When the vehicle wheels 104 are configured into the second configuration 134, the support wheels 300 are unstowed to support the RCV 100 when landing and sitting on the ground during the aerial mobility. It should be further appreciated that other embodiments are contemplated for supporting the RCV 100 while the RCV 100 is being configured between the first configuration 132, second configuration 134 and/or third configuration 136.

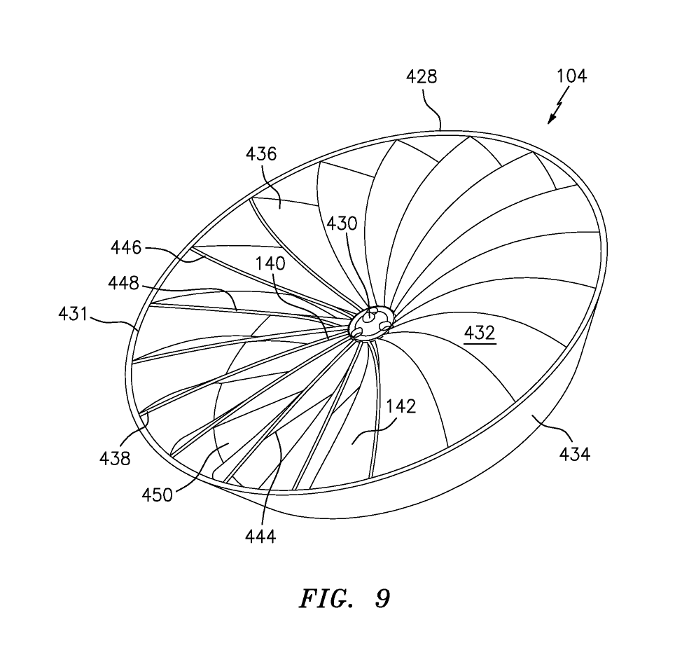

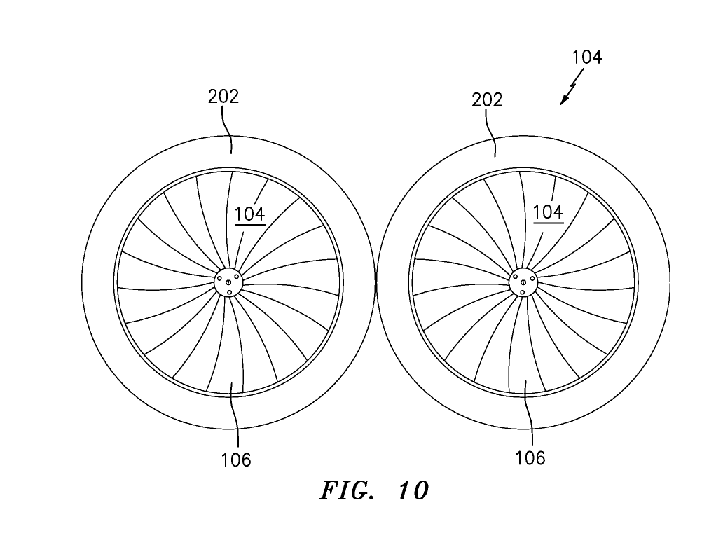

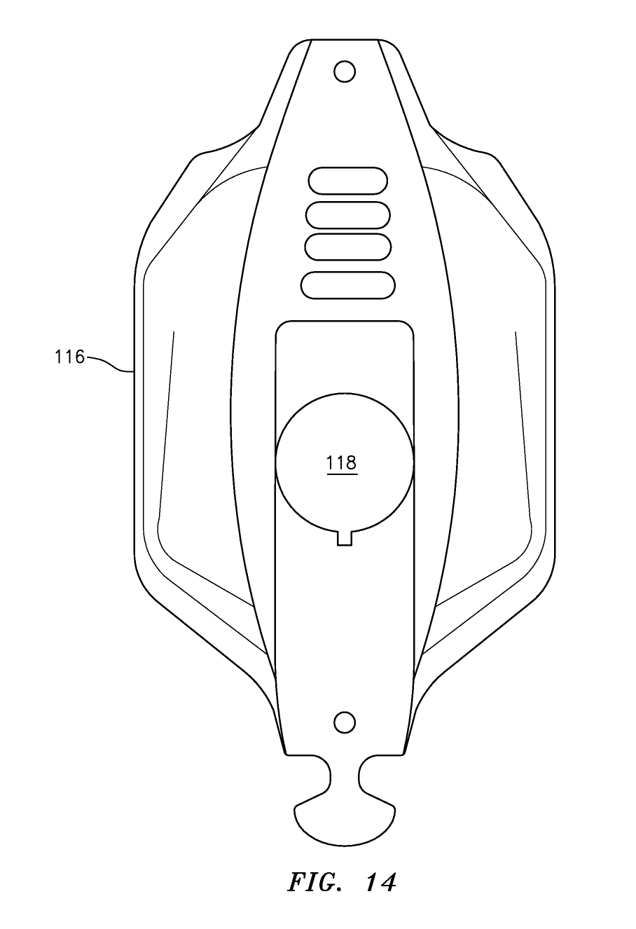

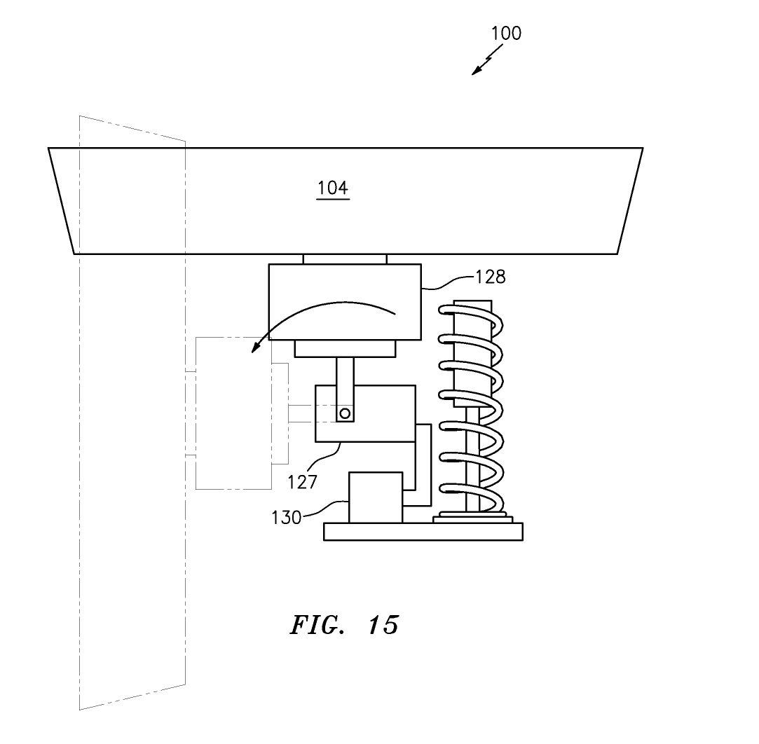

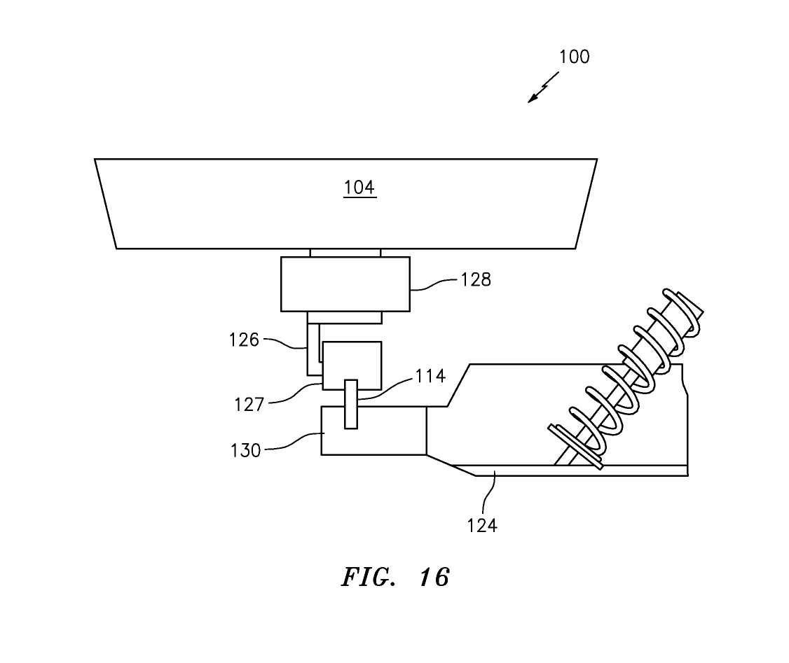

Referring to FIGS. 9-15, it should be appreciated that one of the novel and unique features of the present invention is the vehicle wheel 104, wherein each of the vehicle wheels 104 may include a wheel tire portion and/or a wheel rim 428. The wheel rim 428 is circular in shape and includes a rim front 429, a rim rear 431, a rim center structure 430, a rim support structure 431 having a rim inner structure 432 and a rim outer structure 434, wherein the rim inner structure 432 connects the rim center structure 430 with the rim outer structure 434. The rim inner structure 432 is constructed from a plurality of rim (fan) blades 436 which are distributed along the inner circumference of the wheel rim 428. It should be appreciated that each of the plurality of fan blades 436 includes a leading edge 438, a trailing edge 440, a rim front 442, a rim back 444, an outer edge 446 and a blade center portion 448 which separates the leading edge 438 from the trailing edge 440. This configuration allows the vehicle wheel 104 to have multi-functionality and be used for ground mobility, aerial mobility and aquatic mobility.

Each of the fan blades 436 may be positioned relative to adjacent fan blades 436 such that a portion of the blade center portion 448 of one of the fan blades 436 partially overlaps the blade center portion 448 of the adjacent fan blade 436. Additionally, each of the fan blades 436 may be positioned relative to the adjacent blades 436 such that a flow channel 450 is created between each fan blade 436 and its adjacent fan blade 436. As such, when the vehicle wheels 104 are rotating, the rotation of the fan blades 436 generates an airflow into the rim front 429 through the flow channel 450 and out of the rim rear 431. When the vehicle wheel(s) 104 are configured into the second configuration 134 (i.e. rim front 429 directed toward vehicle top 110), this airflow generates lift causing the RCV 100 to have aerial mobility. Additionally, each of the vehicle wheel(s) 104 may include a tire portion 452 located along the rim outer structure 144 such that when the vehicle wheel(s) 104 are configured into the first configuration 132 (i.e. rim front 429 directed toward vehicle side 112), the tire portion 152 contacts the ground such that the when the vehicle wheels 104 rotate normally, the RCV 100 has ground mobility capability. When the vehicle wheel(s) 104 are configured into the third configuration 136 (i.e. rim front 429 directed toward vehicle front 106), this airflow generates thrust/pull causing the RCV 100 to have aquatic mobility.

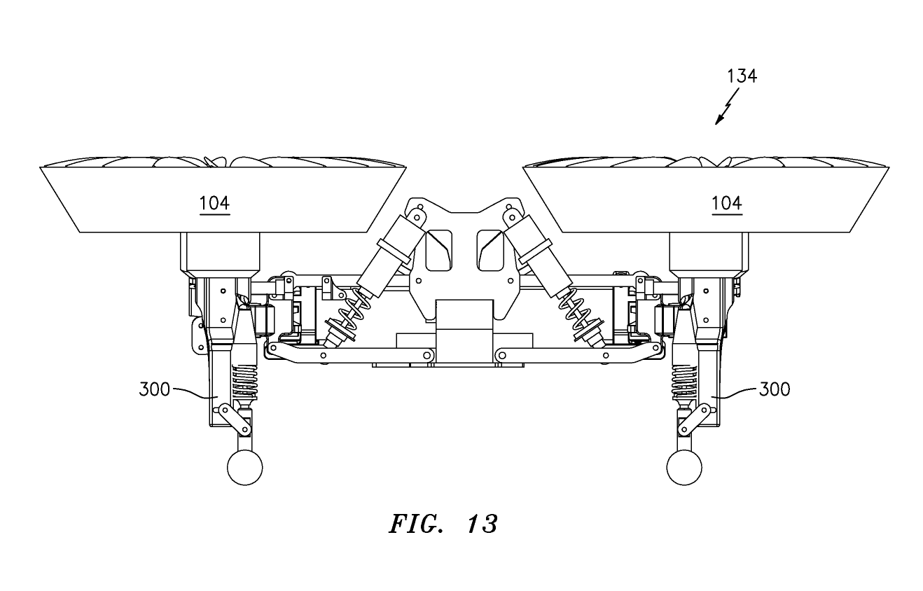

Furthermore, referring to FIG. 11A and FIG. 11B, the vehicle rim outer structure 434 may be a flat surface that is angled at an angle 13, wherein 13 may be any angle between about 0° (relative to a flat surface) and about 60°.

It should be appreciated that in one embodiment, the vehicle wheels 104 include a first vehicle wheel 200 and a second vehicle wheel 202, wherein the first vehicle wheel 200 includes fan blades 140 that are configured in a clockwise configuration when viewed from the vehicle front 106 and the second vehicle wheel 202 includes fan blades 140 that are configured in a counter-clockwise configuration when viewed from the vehicle front 106. In this embodiment, the vehicle wheels 104 are configured such that one set of vehicle wheels 104 (either the first vehicle wheel 200 or the second vehicle wheel 202) are located diagonally from each other and the other set of vehicle wheels 104 (the other of either the first vehicle wheel 200 or the second vehicle wheel 202) are also located diagonally from each other. For example, a first vehicle wheel 200 may be located on the vehicle front 106 right side and the vehicle rear 108 left side and a second vehicle wheel 202 may be located on the vehicle front left side and the vehicle rear right side (or vise versa).

It should be appreciated that in another embodiment, the vehicle wheels 104 that are meant to be located one side of the RCV 100 (i.e. either right or left side) have fan blades 136 that are oriented in one direction and the vehicle wheels 104 that are meant to be located on the other side of the RCV 100 (i.e. either the left or right side) have fan blades 140 that are oriented in the opposite direction. This is because the vehicle wheels 104 on one side of the RCV 100 may be configured to rotate in one direction and the vehicle wheels 104 on the other side of the RCV 100 may be configured to rotate in the opposite direction.

It should be appreciated that FIG. 15 and FIG. 16 illustrate the transformation of the RCV 100 between the second configuration(FIG. 16 and FIG. 12) and a third configuration which utilizes the propeller wheel for aquatic use and also potentially for faster forward flight. The orientation of FIG. 16 can be referenced to the left side of FIG. 13. The difference is FIG. 16 shows a second servo motor for rotating the prop wheel about an additional axis. FIG. 15 is simply the side view of FIG. 16 and the dotted outline represents a potential third configuration in which the rim front 429 faces toward the vehicle front 106 for propelling the vehicle 100 through a liquid environment by utilizing a second servo motor. It should be appreciated that FIG. 15 and FIG. 16 illustrate one embodiment of an RCV 100 for accomplishing the transition between the first and/or second configuration into the third configuration, wherein the RCV 100 includes an additional servo motor 127 which communicates the arm motors 130 with the wheel motors 128. This additional servo motor 127 allows the arm motors 130 and the wheel motors 128 to cooperate to configure the wheels into the third configuration. It should be appreciated that in another embodiment, the additional servo motor 127 may be located between the arm motors 130 and the first arm portion 124 to achieve the same configuration.

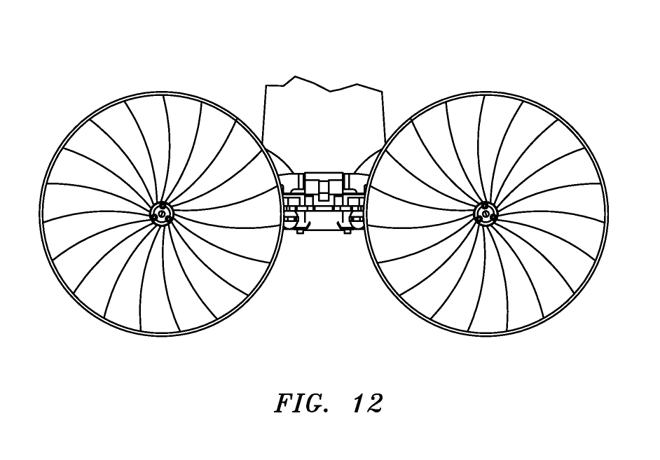

Referring to FIG. 10 for example, two vehicle wheels 104 are shown and include the first vehicle wheel 200 and the second vehicle wheel 202. The first vehicle wheel 200 is shown having fan blades 436 configured in one orientation (i.e. clockwise) and the second vehicle wheel 202 is shown having fan blades 436 configured in an opposite orientation (i.e. counter-clockwise). This is because in one or more configurations the vehicle wheels 104 on one side of the RCV 100 may rotate in one direction while the vehicle wheels 104 on the other side of the RCV 100 may rotate in the opposite direction. As such, the fan blades 436 have to be configured to rotate in a manner that generates lift.

It should be appreciated that in another embodiment, the vehicle wheels 104 may have fan blades 436 that have the same orientation and the motors may be controllably adjusted to rotate such that the fan blades 436 generate lift. As such, when the vehicle wheels 104 are configured for ground mobility (i.e. first configuration 132), the vehicle wheels 104 on one side of the RCV 100 will rotate in one direction and the vehicle wheels 104 on the other side of the RCV 100 will rotate in the opposite direction. When the vehicle wheels 104 are configured for aerial mobility (i.e. second configuration 134 and/or third configuration 136), the motors that control the rotation of the vehicle wheels 104 may be configured such that all of the vehicle wheels 104 will rotate in the direction required to generate lift (for aerial use) or forward thrust (for aquatic use).

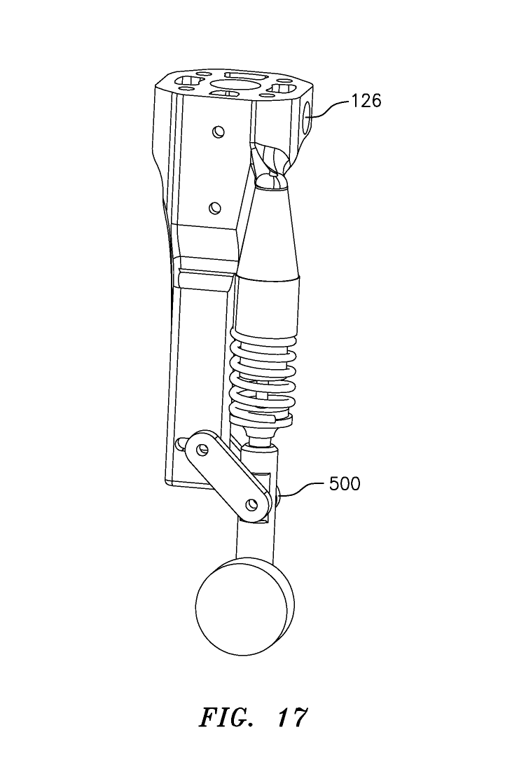

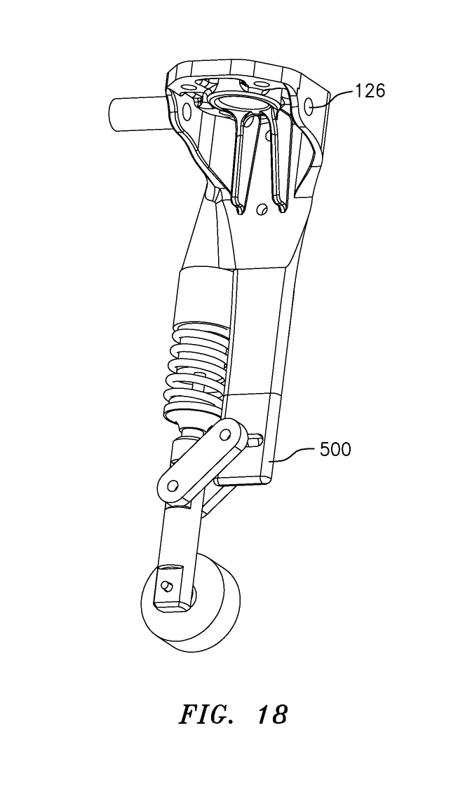

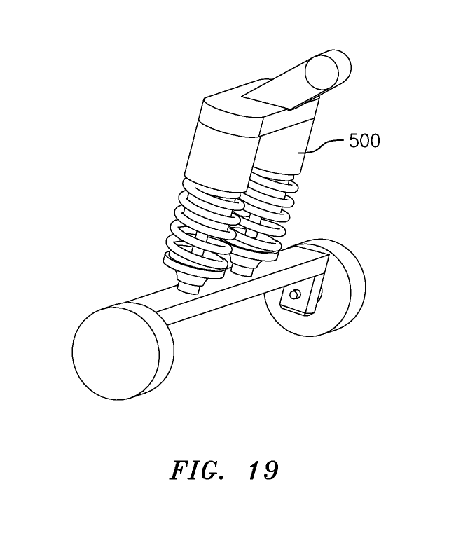

Moreover, it should be appreciated that the vehicle body cover 108 may be configured to be easily connected to the vehicle top 110 of the vehicle main body 102 via any method and/or device suitable to the desired end purpose, such as snaps, clips, screws, Hook and Loop Fasteners, etc. It is contemplated that the invention disclosed herein may also be applied to vehicle of any size, and as such, may be implemented in vehicles having much greater sizes, such as passenger vehicles. As such, passenger vehicles may include all of the elements of the present invention or only a portion and the elements may be mixed and used as desired, such as the wheel rim 428. Referring to FIG. 17, FIG. 18 and FIG. 19, additional embodiments of a rear motor mount/transition wheel leg 500 and a front transition wheel leg 502 for the Remote Control Vehicle (RCV) is shown in accordance with another embodiment of the invention.

It should be appreciated that the invention is not only limited to ground and aerial use, but also to aquatic use. As such, the vehicle may be used underwater. Moreover, additional information is provided in the attached appendix where the information does not and is not intended to limit the scope of the invention. Accordingly, all of the information contained herein may be combined together (individually or wholly) or taken singly to achieve varying embodiments of the invention and to add to the scope of the invention without limiting the invention to a particular embodiment.

Moreover, while the invention has been described with reference to an exemplary embodiment, it will be understood by those skilled in the art that various changes, omissions and/or additions may be made and equivalents may be substituted for elements thereof without departing from the spirit and scope of the invention. In addition, as desired the elements and characteristics of the disclosed embodiments may be combined in whole or in part and/or many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

I claim:

1. A multi-dimensional vehicle configured for aerial and ground mobility, the multi-dimensional vehicle comprising:
a vehicle body;
a plurality of vehicle wheels, wherein the plurality of vehicle wheels are movably associated with the vehicle body and configurable between a ground mobility configuration and an aerial mobility configuration; and
a control device, wherein the control device is configured for wireless communication and is associated with the vehicle body and the plurality of vehicle wheels to controllably operate the plurality of vehicle wheels and to controllably configure the plurality of vehicle wheels between the ground mobility configuration and the aerial mobility configuration,
wherein each of the plurality of vehicle wheels include a wheel rim having an inner rim circumference and a plurality of fan blades distributed along the inner rim circumference, wherein the plurality of fan blades are configured to create a flow channel between each of the plurality of fan blades and an adjacent fan blade.

2. The multi-dimensional vehicle of claim 1, wherein the vehicle body is configurable into an aquatic mobility configuration.

3. The multi-dimensional vehicle of claim 1, further comprising a vehicle wheel arm having a first arm portion associated with a second arm portion, wherein the first arm portion is associated with the vehicle body and wherein the second arm portion is associated with the vehicle wheel.

4. The multi-dimensional vehicle of claim 3, further comprising an arm motor associated with the vehicle wheel arm, wherein the arm motor is configured to controllably configure the second arm portion between a first configuration and a second configuration.

5. The multi-dimensional vehicle of claim 4, wherein when the second arm portion is configured into the first configuration, the multi-dimensional vehicle is configured for ground mobility, when the second arm portion is configured into the second configuration, the multi-dimensional vehicle is configured for aerial mobility and when the second arm portion is configured into the third configuration, the multi-dimensional vehicle is configured for aquatic mobility.

6. The multi-dimensional vehicle of claim 5, wherein when the second arm portion is configured into the second configuration, the plurality of vehicle wheels are rotatable such that the plurality of fan blades create lift.

7. The multi-dimensional vehicle of claim 5, wherein when the second arm portion is configured into the third configuration, the plurality of vehicle wheels are rotatable such that the plurality of fan blades causes at least one of pull and thrust.

9. The multi-dimensional vehicle of claim 1, wherein the control device is associated with the plurality of vehicle wheels via at least one arm motor and at least one arm portion, wherein the at least one arm motor is configured to controllably configure the at least one arm portion between a first configuration and at least one of a second configuration and a third configuration.

10. The multi-dimensional vehicle of claim 1, further comprising a remote handheld device, wherein the remote handheld device is configured to be in wireless communication with the control device to control the multi-dimensional vehicle.

11. A multi-dimensional vehicle configured for aerial and ground mobility, the multi-dimensional vehicle comprising:
a vehicle body;
a plurality of vehicle wheels rotatably associated with the vehicle body, wherein the plurality of vehicle wheels are movably associated with the vehicle body and configurable between a plurality of mobility configurations; and
a control device, wherein the control device is associated with the plurality of vehicle wheels to controllably operate the plurality of vehicle wheels and to controllably configure the plurality of vehicle wheels between the plurality of mobility configurations,
wherein each of the plurality of vehicle wheels include a wheel rim having an inner rim circumference and a plurality of fan blades distributed along the inner rim circumference.

12. The multi-dimensional vehicle of claim 11, wherein the plurality of mobility configurations includes at least one of a ground mobility configuration, an aerial configuration and an aquatic configuration.

13. The multi-dimensional vehicle of claim 11, further comprising a vehicle wheel arm having a first arm portion associated with a second arm portion, wherein the first arm portion is associated with the vehicle body and wherein the second arm portion is associated with the vehicle wheel.

14. The multi-dimensional vehicle of claim 13, further comprising an arm motor associated with the vehicle wheel arm, wherein the arm motor is configured to controllably configure the second arm portion between the plurality of mobility configurations.

15. The multi-dimensional vehicle of claim 13, wherein the plurality of mobility configurations include at least one of a first configuration, a second configuration and a third configuration.

16. The multi-dimensional vehicle of claim 15, wherein when the second arm portion is configured into the first configuration, the multi-dimensional vehicle is configured for ground mobility, when the second arm portion is configured into the second configuration, the multi-dimensional vehicle is configured for aerial mobility and when the second arm portion is configured into the third configuration, the multi-dimensional vehicle is configured for aquatic mobility.

17. A vehicle wheel for use with a multi-dimensional vehicle configured for aerial and ground mobility, the vehicle wheel comprising:
a wheel rim, wherein the wheel rim includes,
a rim support structure having a rim outer structure and a rim inner structure;
a rim center structure; and
a plurality of rim blades,
wherein the plurality of rim blades connect the rim center structure with the rim inner structure, and
wherein the plurality of rim blades are configured to generate an air flow between the plurality of rim blades when the vehicle wheel is rotated.

18. The vehicle wheel of claim 17, wherein the rim inner structure includes an inner circumference and wherein the plurality of rim blades are distributed along the inner circumference such that each of the plurality of rim blades separated from an adjacent rim blade via a flow channel.

19. The vehicle wheel of claim 17, wherein the wheel rim includes a rim front and a rim back, and wherein when the vehicle wheel is rotated in one direction the air flow is directed through the flow channel from the rim front to the rim back and when the wheel is rotated in the opposite direction the air flow is directed through the flow channel from the rim back to the rim front.

20. The vehicle wheel of claim 17, wherein the rim outer structure is angled between about 0° and about 60°.
